(19) United States
(12) Patent Application Publication
(10) Pub. No.: US 2025/0304350 A1
(43) Pub. Date: Oct. 2, 2025

(54) Card Based Lid with Scoop Holder and Scoop

(71) Applicant: N.V. Nutricia, Zoetermeer (NL)

(72) Inventors: Marlies Lutgendorf, Utrecht (NL); Marcel Verkaik, Utrecht (NL)

(73) Assignee: N.V. Nutricia, Zoetermeer (NL)

(21) Appl. No.: 19/171,508

(22) Filed: Apr. 7, 2025

Related U.S. Application Data
(62) Division of application No. PCT/EP2023/078807, filed on Oct. 17, 2023.

(30) Foreign Application Priority Data
Oct. 17, 2022 (WO) PCT/EP2022/078860

(51) Int. Cl. B65D 77/24; A61J 1/14; B31D 5/00; B65D 43/16; B65D 51/24

(52) U.S. Cl. CPC B65D 77/245; A61J 1/1462; B31D 5/0086; B65D 43/16; B65D 51/24; B65D 2543/00194; B65D 2543/00268

(57) ABSTRACT

Packages for infant formula are disclosed herein. The packages include a container having an access opening to an interior space, for receiving the infant formula and a closure. Closures for the infant formula package are also disclosed herein. The closures are arranged for selectively closing the access opening and include a lid and a scoop holder located on an underside of the lid to retain a scoop, and the scoop holder has an apertured plate including an apertured portion with an aperture therethrough to receive at least part of the scoop, and both the lid and the scoop holder are formed of card-based material.

### BACKGROUND OF THE INVENTION

### Field of the Invention

The present invention relates to lids for container provided with scoop holders for retaining a scoop, in particular in the context of packages for containing and dispensing powdered infant nutrition or milk formula or similar sensitive products.

### Description of the Related Art

Powdered material, such as infant milk formula, has been sold in various forms of package for many years. Metal cans were initially the preferred container as they were relatively easy and cheap to produce and could be sealed for long term storage. The seal comprised an aluminium foil across the mouth of the container that was removed on first use. As a single container would be used for an extended period, the containers were provided with re-closable plastic lids which gripped over the outer rim of the can. A measuring scoop was frequently included with the container, either packaged separately or within the can itself.

More recently, alternative packaging forms have become available which improve on the existing cans. These include plastic and foil laminate container bodies and hinged lid assemblies having a facility to receive and retain a measuring scoop. In particular, it has been found desirable that the scoop is not included within the product containing space as this may require more stringent requirements on the scoop production and introduction of the scoop at a late production stage is excluded. One such package is described in US 2008041861, having a seal for initially closing the package and a space between the seal and an upper edge of the container for partially receiving the scoop prior to use. Further developments include tubs of plastic material having a position within the lid for receipt of a scoop such as shown in WO 2014/129903.

For infant formula packages, the intention is generally that the scoop is placed in its scoop holder after each use, in order to keep it sterile and available for the next use rather than it being left in the powder, requiring a user to engage the powder with their fingers in order to retrieve it. Nevertheless, effective and correct usage of a scoop holder depends upon it being well designed and simple to use. For existing plastic lid constructions, there is considerable flexibility in the design of the scoop holder, especially when injection moulding techniques are applied. Presently, alternative closures that do not require plastic are being contemplated. It would be desirable that such alternative closures could also be provided with scoop holders that would be acceptable to users.

### BRIEF SUMMARY OF THE INVENTION

According to the invention there is provided a closure for an infant formula package, the package comprising a container having an access opening to an interior space, for receiving the infant formula, whereby the closure is arranged for selectively closing the access opening, the closure comprising a lid with a scoop holder located on an underside of the lid to retain a scoop, wherein the scoop holder comprises an apertured plate having an apertured portion with an aperture therethrough to receive at least part of the scoop, and wherein both the lid and the scoop holder are formed of card-based material. By making both the lid and the scoop holder of card-based material, improved recycling can be achieved, in particular if the container is also of card-based material.

The card-based material may comprise any suitable card or paper construction in a single or multiple layers, including reinforced, corrugated, honeycomb and foamed constructions. In this context, formed of card-based material is intended to denote that the respective component is predominantly of card and can be disposed of in the existing recycling streams, in particular the paper and card waste streams. It will be understood that the precise requirement in terms of cellulose or paper content may vary from country to country and will be detailed further below. Furthermore, card-based may be understood to distinguish over components that are predominantly of plastic or metal.

The scoop holder may have any appropriate form, in particular depending on the shape of the scoop or the part of the scoop that is to be gripped. The apertured plate may have any appropriate shape, in particular it may be disk shaped, rectangular, square or the like. The shape may also follow the contour of the lid to which it is attached.

In an embodiment, the apertured plate comprises an attachment portion attached to the lid and surrounding the apertured portion. In particular, the attachment portion may completely surround the apertured portion. This is particularly relevant where the attachment portion forms a hermetic connection with the lid. This also provides a sturdier attachment to the lid. It is however not excluded that the attachment portion only partially surrounds the apertured portion or that the aperture is open at one side, without connection to the lid.

The scoop holder may be limited to just a central area of the lid, thus minimising material usage. Alternatively, the scoop holder may be substantially co-extensive with the lid. This is especially convenient when other portions of the scoop holder have further functions within the package or when for manufacturing reasons it is desirable that the edges of the lid and the scoop holder coincide.

According to an embodiment, the aperture in the aperture plate is shaped to match at least part of an outline of the scoop, to prevent motion of the scoop within a plane parallel to the apertured plate. The aperture may be contoured to correspond with a portion of the scoop's outline to allow the scoop to be partially inserted into the aperture, ensuring proper placement of the scoop while minimizing movement when the closure is opened or closed. Thus, the aperture can take any suitable shape to improve scoop stability, like a semicircle mirroring the scoop's front half. Alternatively, the shape of the aperture may correspond to the entire outline of the scoop, for example, a top outline of the scoop in which both bowl and handle are substantially colinear. This further improves the ability of the scoop holder to immobilize the scoop under the lid.

In an embodiment, the apertured portion comprises a strip, crossing the aperture and connected to opposite sides of an edge of the aperture to form a loop extending downwards from the apertured plate, allowing a handle of the scoop to slide through and underneath of the apertured plate. The loop extending downwards serves as a vertical restraint when the package is closed, preventing the scoop from falling downward, which is crucial for preventing the scoop from accidentally dropping into the powdered infant formula and ensuring its hygiene. The loop further ensures the placement of the scoop while the closure is being open or closed. One or more strips may be used to restraint the scoop, and their location may change depending on physical properties of the scoop such as its size, weight, shape etc. Preferably, the strip crosses the aperture in a direction substantially perpendicular to a longitudinal axis of the scoop when the scoop is in the scoop holder, which minimising material usage. Alternatively, the strip crosses the aperture in a direction substantially perpendicular to a longitudinal axis of the scoop, which allows for the one or more loops to restrain the scoop along its length.

If the strip crosses the aperture in a direction substantially perpendicular to a longitudinal axis of the scoop, the loop may be shaped to enclose a segment of the handle of the scoop. In other words, a cross section of the loop may correspond to a cross section of the scoop's handle with a slightly larger area to easily allow the handle to pass through. These cross-sections preferably have a flat side or portion to maximize the contact of the handle with the lid when the scoop is in the scoop holder. Nevertheless, various handle and scoop shapes are permissible, as the loop secures the handle with a sufficient level of tightness.

According to another embodiment the apertured portion is shaped to protrude downwards, out of a plane of the attachment portion whereby the aperture is spaced from the underside of the lid. The scoop holder may thus have the form of a shallow dish or plate, with the attachment portion attached to the underside of the lid and the aperture passing through the bottom of the dish. The plane of the attachment portion may thus correspond to the plane of the underside of the lid.

The scoop holder may also comprise a transition portion between the attachment portion and the apertured portion. The transition portion spaces the apertured portion from the underside of the lid. In an embodiment, the aperture can extend at least partially into the transition portion. This ensures that the aperture is not planar but also has a three-dimensional contour.

According to an embodiment, the aperture is I shaped and the crosses of the I are located in the transition portion. The stem of the I may traverse the apertured portion. In the case of a circular apertured portion, the stem of the I may bisect a diagonal of the apertured portion. Although reference is given to an I shape, it will be understood that it may also be H-shaped, depending upon the relative size of the respective branches. Edges of the aperture in the apertured portion may thus form flaps that can engage the handle of a scoop as it is inserted by sliding along an axis of the I. For this reason, it may be preferred that the stem of the I is of a sufficient length to provide adequate support for the scoop.

In embodiments, the aperture may have a length of between 10 mm and 30 mm, preferably between 15 mm and 20 mm. The scoop holder may also be arranged to grip a handle of the scoop over a length of between 10 mm and 30 mm, preferably between 15 mm and 20 mm.

In the above, the scoop holder is an apertured plate affixed to an underside of a lid. It will nevertheless be understood that the lid itself can be provided with a downwardly bowed portion provided with an aperture, forming the scoop holder. The integrity of the lid can then be maintained by providing a cover over the bowed portion of the lid, thus sealing above the aperture.

In one embodiment, a peripheral edge of the scoop holder is arranged to extend outwardly to such an extent that it can engage with the container, preferably to sealingly close the access opening. The scoop holder may thus provide or participate in the sealing function. This is particularly important for infant formula containers where a high degree of re-closure is required to prevent degradation of the contents or ingress of unwanted materials or organisms once the package is first opened. The peripheral edge may be arranged to be floating either at or adjacent to its extremity.

The peripheral edge of the apertured plate may also extend downwardly away from the lid or at least away from a central portion of the lid where the aperture is located. It may extend downwards to a position below a level of the apertured portion. In this context, downwards is intended to refer to the normal orientation of the lid in its closed state. It will be understood that once opened, the lid may be inverted. It may also be understood that the central portion of the lid may also be considered to extend upwards with respect to the peripheral edge. From either perspective, a space is created beneath the lid in which the scoop may be located.

The closure may be removable in its entirety from the container. In one preferred embodiment, the closure may further comprise a hinge, pivotally connecting the lid to the container. The hinge may also be formed of card or paper-based material and is preferably a form of living hinge, relying on the ability of paper-based material to fold. The hinge may be formed together with a collar, attached to an upper edge of the container around the access opening. During manufacture, the collar may be considered part of the closure but for the purpose of the present disclosure, once attached to the container it may be considered part of the container and may also participate in the closure function by interaction with the lid or the peripheral edge of the apertured plate.

In an embodiment, the hinge is aligned with the aperture so that the scoop may be retained in a position aligned with the hinge.

According to the invention, the closure may be formed of card-based material. This is intended to mean that all of the elements of the closure are card based, including the lid, the apertured plate and the hinge. The scoop itself need not be card based although it is not excluded that card-based scoops may also be provided. The package in its entirety may comprise elements that are not completely made of card, some of which may be removed prior to use. In particular, there may be barrier layers and connections or joints that use other materials, not excluding metals or polymers. In the present context, card-based material denotes a material formed from a cellulose based pulp, which may further include one or more layers of non cellulose materials, such as barrier layers, sealing layers, adhesive layers and decorative layers. It may comprise any suitable card or paper construction in a single or multiple layers, including reinforced, corrugated, honeycomb, moulded and foamed constructions The card-based materials may also have inclusions such as fillers, pigments, inks, and the like. It is well recognised that different definitions and requirements may be applied for the manufacturing and disposal of paper and card and, where reference is made below to percentages of paper, these include all of the paper constituents, including cellulose fibers, mineral filler, bound water, paper additives, size, bulk pigment and latex binders. The percentages of non-paper will apply to all other layers not usually considered to be paper, including print, varnish and non-water-soluble adhesive layers and the barrier layers as mentioned elsewhere.

In an embodiment, the card-based material consists of at least 85 wt % paper or at least 90 wt % paper, preferably at least 95 wt % paper and more preferably at least 98 wt % paper or even at least 99 wt % of paper. The precise amount may also be adapted according to local regulations concerning recycling.

It will be understood that the above values for paper content may apply to each of the individual components separately and that the card-based material of the lid may have a different paper content to that of the scoop holder and/or the container. In an embodiment, the package taken as a whole in its used state may have an overall paper content of at least 85 wt % paper or at least 90 wt % paper, preferably at least 95 wt % paper and more preferably at least 98 wt % paper or even at least 99 wt % of paper

The invention also relates to a scoop holder for integration into a closure as described above or hereinafter and to a combination of a scoop with such a scoop holder. In particular, the scoop may comprise a handle, having a T-shaped cross-sectional profile. For the case that the scoop holder comprises an I-shaped aperture as described above, the handle may be inserted into the aperture with the cross of the T located in the crosses of the I and the stem of the T extending out of the stem of the I. A particular advantage of the aperture configuration is that the scoop may be inserted from either side, making it suitable for both left and right-handed users.

The scoop may be of any appropriate size for dosing of infant formula, in particular it may have a bowl with a volume of between 2 ml and 20 ml, preferably between 6 ml and 20 ml, in particular between 8 ml and 14 ml.

The invention also relates to a package comprising a container and a closure as described above or hereinafter, in particular wherein the container also consists essentially of card-based material.

The invention further relates to methods of manufacturing a scoop holder, in a method, the method comprises providing a plate shaped portion of card-based material; cutting an aperture into the plate to form an apertured plate, deforming the plate into a dish shape with a rim and with the aperture at a bottom of the dish; and attaching the apertured plate at least by its rim to the underside of a lid. In an alternative method, the method comprises: providing a plate shaped portion of card-based material; cutting an aperture into the plate to form an apertured plate, wherein the aperture is cut to match at least part of an outline of a scoop; attaching the apertured plate at least by its rim to the underside of a lid; connecting a strip across the aperture; and attaching the strip to opposite sides of an edge of the aperture thereby forming a loop extending downwards from the apertured plate.

Providing the plate and cutting of the aperture may both take place by die-cutting and both steps may take place in a single action. Attaching of the apertured plate to the underside of the lid may take place by any suitable means including welding, heat sealing and the like. Preferably it takes place using an adhesive, in particular an adhesive suitable for paper-based products.

### BRIEF DESCRIPTION OF THE DRAWINGS

The features and advantages of the invention will be appreciated upon reference to the following drawings of a number of exemplary embodiments, in which:

FIG. 1A shows in perspective view of a scoop holder according to an embodiment of the present invention.

FIG. 1B shows a top view of the scoop holder of FIG. 1A.

FIG. 1C shows a cross-sectional view through the scoop holder of FIG. 1A on the sagittal plane X-Z.

FIG. 2A shows a top view of a scoop holder according to a second embodiment of the present invention.

FIG. 2B shows a cross-sectional view through the scoop holder of FIG. 2A on the sagittal plane X-Z.

FIG. 2C shows in perspective view a scoop holder according to a third embodiment of the present invention.

FIG. 2D shows a top view of the scoop holder of FIG. 2C.

FIG. 2E shows in perspective view the scoop holder of FIG. 2C holding a scoop.

FIG. 2F shows in perspective view the other side of the scoop holder of FIG. 2C.

FIG. 3A shows a perspective view of a card-based closure according to an embodiment of the present invention.

FIG. 3B shows a partially exploded view of the closure of FIG. 3A.

FIG. 3C shows a cross-sectional view through the closure of FIG. 3A on the sagittal plane X-Z.

FIG. 4A shows a perspective view of a card-based package for an infant formula according to an embodiment of the present invention.

FIG. 4B shows a partially exploded view of the package of FIG. 4A.

FIG. 4C shows a cross-sectional view through the package of FIG. 4A on the sagittal plane X-Z.

FIG. 4D shows a closeup of part of the joint between the closure and the container from FIG. 4A

FIG. 5 shows a front view of the package of FIG. 4A with the closure open.

FIG. 6A shows a perspective view of a scoop according to an embodiment of the present invention.

FIG. 6B shows a side view of the scoop of FIG. 6A.

FIG. 7 shows a cross-section through a central region of the closure with the scoop holder holding the scoop.

The figures are meant for illustrative purposes only, and do not serve as restriction of the scope or the protection as laid down by the claims.

### DESCRIPTION OF ILLUSTRATIVE EMBODIMENTS

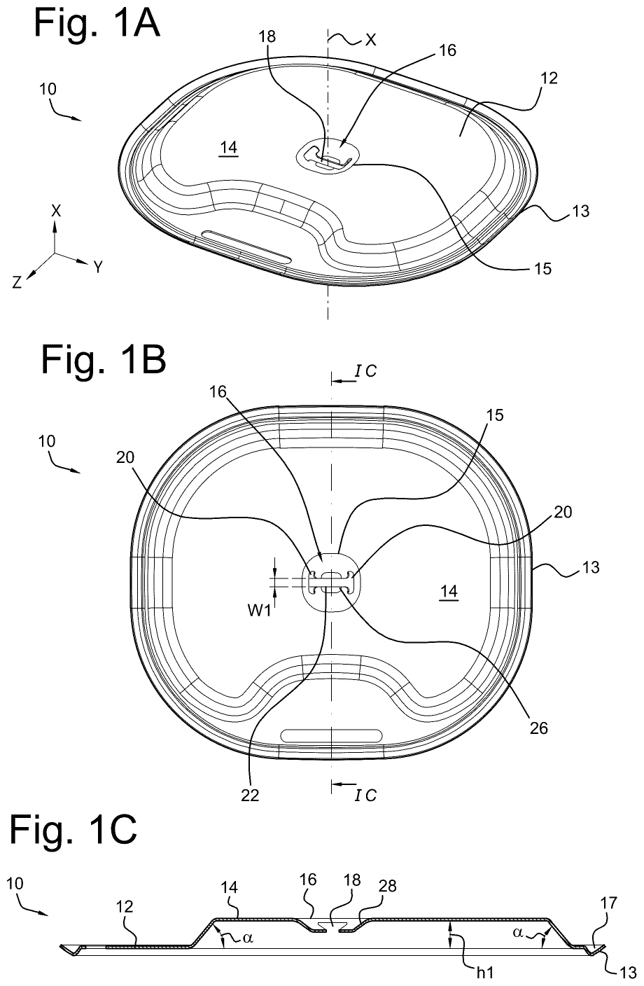

FIG. 1A shows a perspective view of a scoop holder according to an embodiment of the present invention. Scoop holder 10 has a longitudinal axis X-X, by which may be defined a transverse plane X-Y and a sagittal plane X-Z. In the following, reference to upper, lower, top, bottom etc. is given with respect to the scoop holder 10 in its upright condition, with the axis X-X arranged vertically.

The scoop holder 10 comprises a plate 12 with a peripheral plate rim 13, formed as a die-cut plate of card and shaped to be bowed upwards in a central region, such that the scoop holder 10 adopts the shape of an inverted shallow dish, with a height h1 and with a transition angle α (see also FIG. 1C).

The central region of the scoop holder 10 has a planar attachment portion 14 surrounding an apertured portion 16 defined by an aperture rim 15 located in the middle of the plate 12. The apertured portion 16 comprises a die-cut aperture 18 passing through the plate 12 that has the shape of an I with crosses 20 and a stem 22, as shown in FIG. 1B. In the presented embodiment, the stem 22 of the I traverses the apertured portion 16 forming flaps 26 that can engage the handle of a scoop inserted along an axis of the I, as described below with reference to FIG. 7. The stem 22 of the aperture 18 has a width W1.

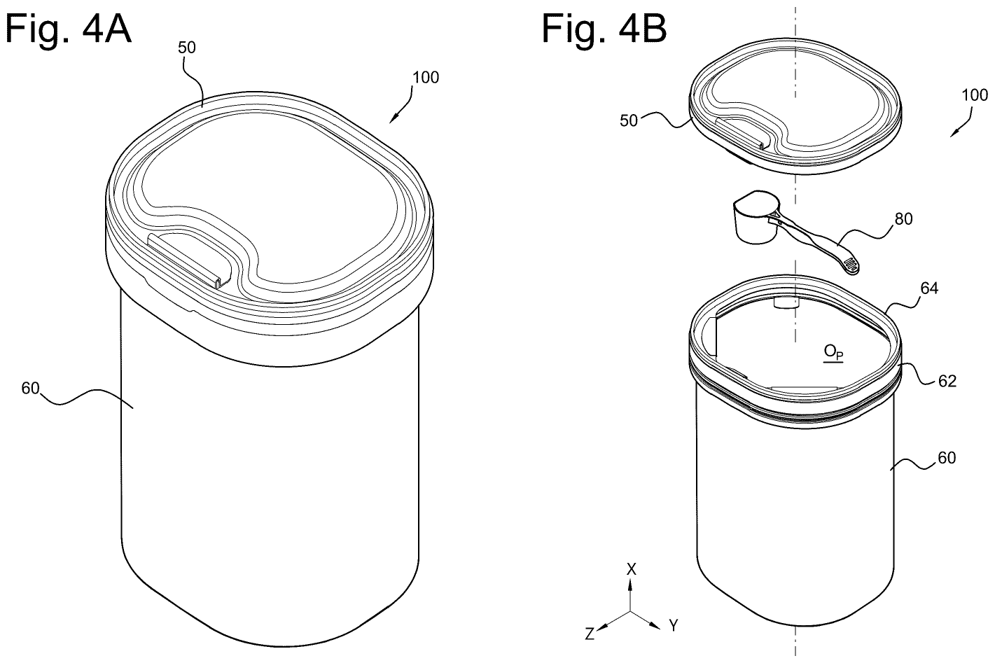

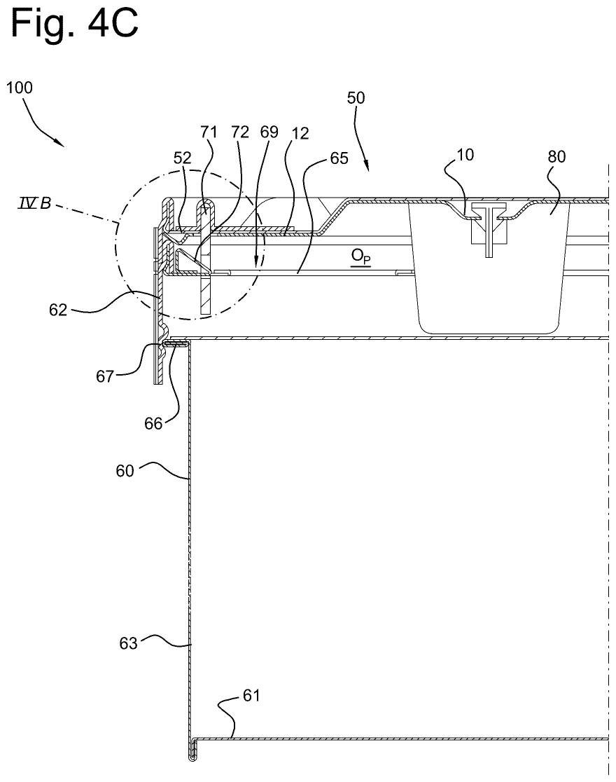

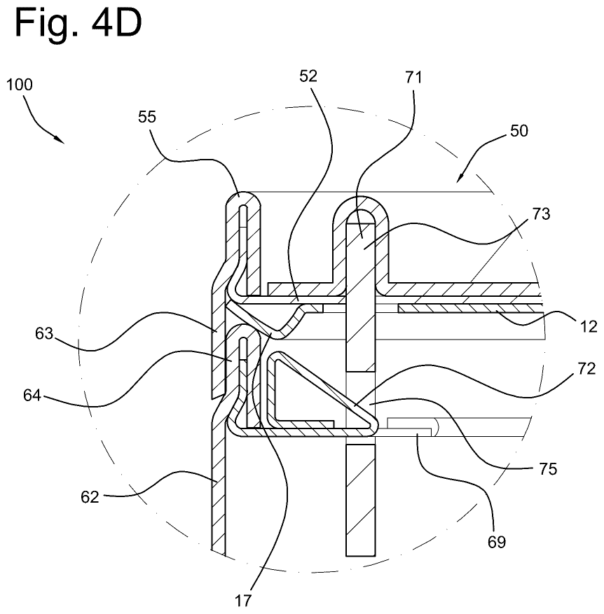

FIG. 1C shows a cross-sectional view through the scoop holder of FIG. 1A on the sagittal plane X-Z. The scoop holder 10 comprises a transition portion 28 located at the apertured portion 16, in which the crosses 20 of the I are located such that the aperture 18 has a three-dimensional contour. In this embodiment, the plate rim 13 has a peripheral section 17 bowed downwards away from the central portion of the plate 12. This configuration allows the peripheral section 17 to flex, providing the plate 12 with a resilient plate rim 13 to such an extent that it can engage with a container. Further details on the engagement of the scoop holder and the container are described below with reference to FIG. 4.

The aperture 18 may have a length of between 10 mm and 30 mm, preferably between 15 mm and 20 mm. The scoop holder 10 may also be arranged to grip a handle of the scoop over a length of between 10 mm and 30 mm, preferably between 15 mm and 20 mm. Abovementioned dimensions are optimized such to reliably hold a scoop suitable to measure powdered infant formula. Yet, it is understood that the dimensions of the aperture 18 can be adapted to other scoop sizes that may require an aperture larger than 30 mm or smaller than 10 mm.

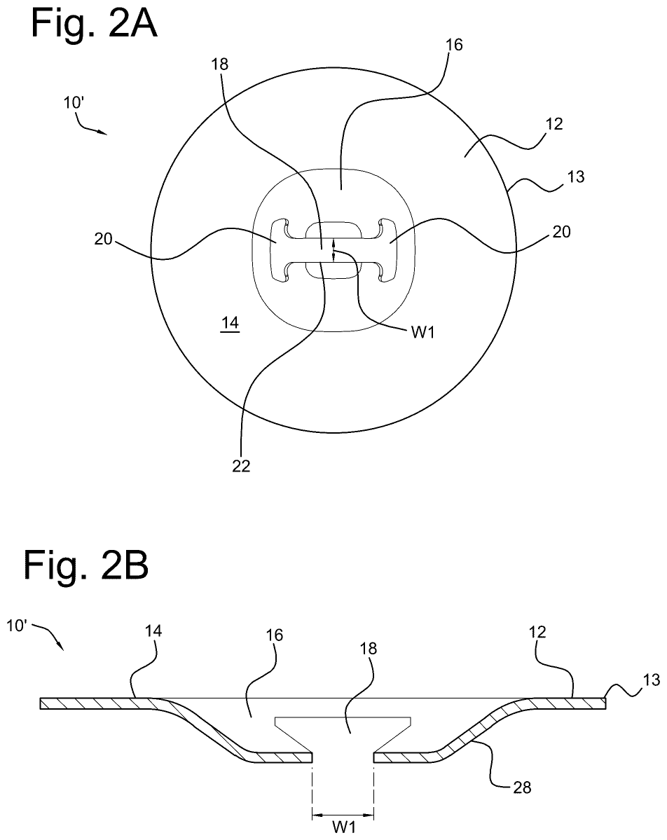

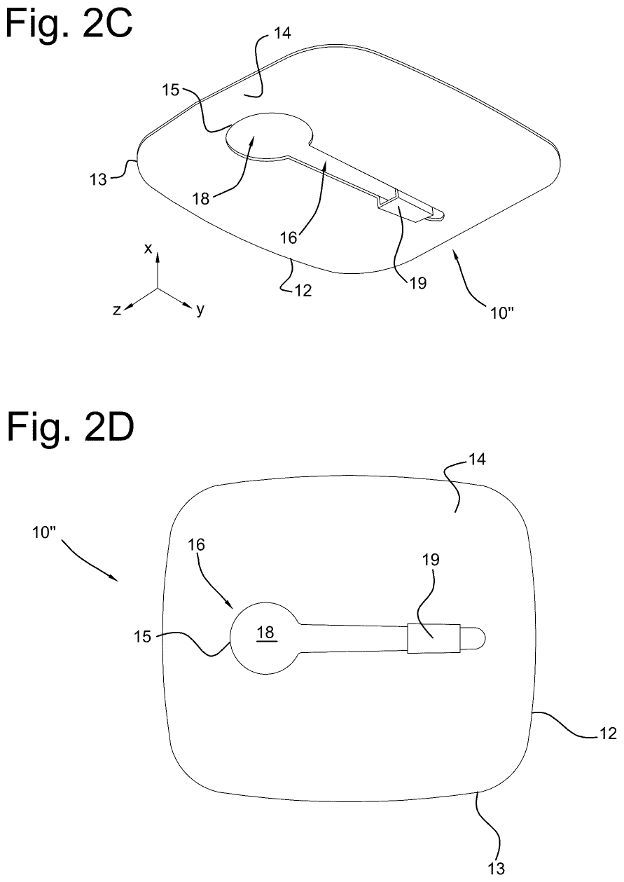

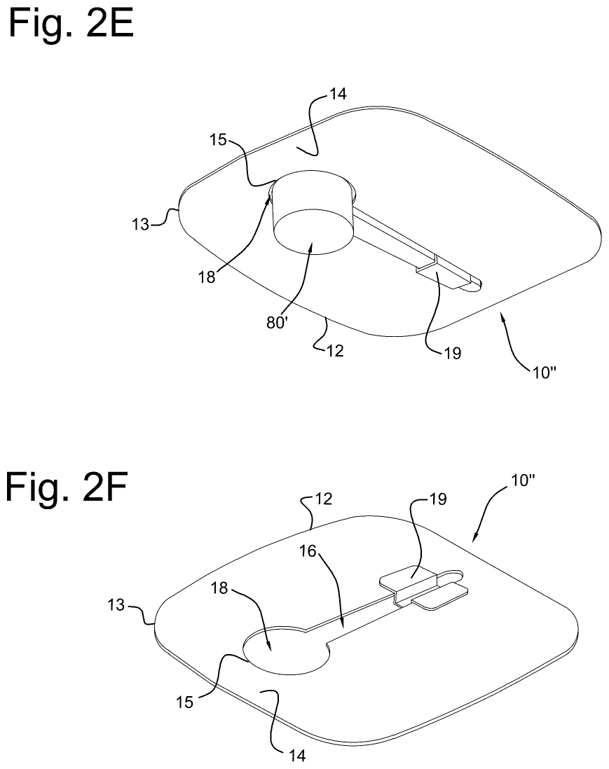

FIGS. 2A and 2B show a scoop holder 10′ according to a second embodiment. In this case, the apertured plate 12 is entirely flat and its attachment portion 14 covers an area smaller than in the previously mentioned embodiment, giving the plate rim 13 a smaller circumference.

FIG. 2C-2F show a scoop holder 10″ according to a third embodiment. Here the aperture portion 16 comprises the aperture 18, and a loop 19 crossing the aperture 18 and connected to opposite sides of an edge of the aperture. In this embodiment, the aperture 18 has a shape corresponding to a top outline of a scoop 80′. Consequently, the scoop 80′ can be partially inserted in the aperture 18 to prevent motion of the scoop 80′ within a plane parallel to the apertured plate (see FIG. 2E). This contributes to a proper placement transversal placement (in plane YZ) of the scoop 80′ when the closure 50 is opened, closed, or when the package 100 is moved around. The loop 19 extends downwards (−X direction) when the closure is in a closed position. In this way, the loop 19 serves as a vertical restraint that prevents the scoop from accidentally dropping into the powdered infant formula while the package 100 is in use. The loop 19 is made of a strip of card-based material that can be connected to the edge of the aperture 18 by any suitable means including welding, heat sealing or an adhesive suitable for paper-based products. As shown in FIG. 2F, the strip can also connect to the plate 12 by attaching opposite end portions of the strip to the attachment portion 14, i.e., to an upper side of the plate 12. In the depicted embodiment, the strip is folded to create a square cross-section that encloses the scoop handle, which is also squared and nearly the same in dimensions. As the loop 19 fully encloses a segment of the handle, it further secures the scoop 80′ in the axis Z-Z.

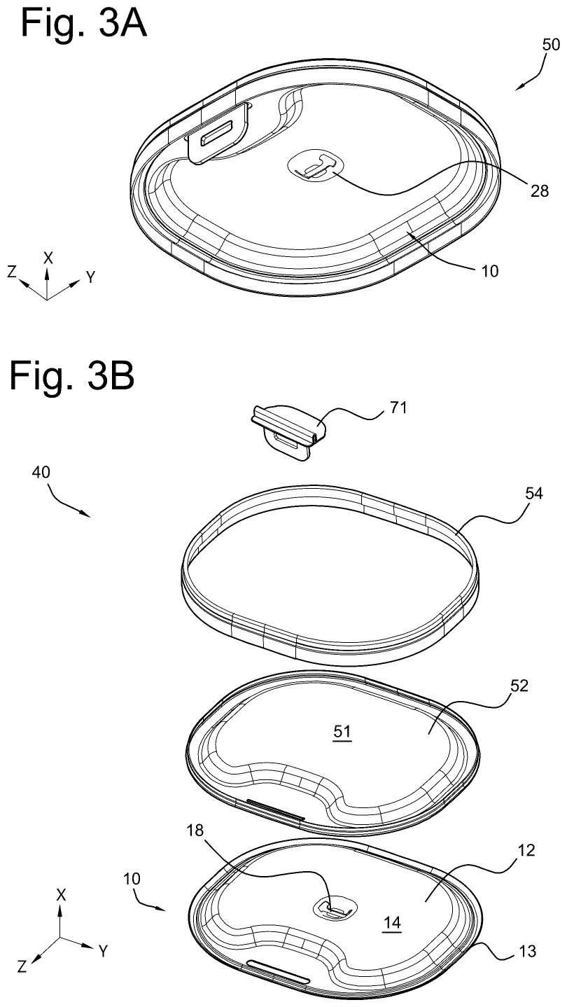

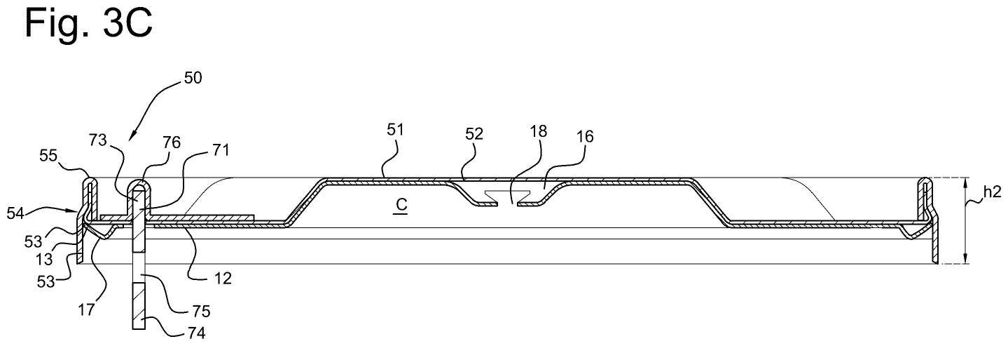

FIG. 3A shows a perspective view of a card-based closure 50 according to an embodiment of the present invention. The scoop holder 10 is located at an underside of the closure 50 such that its transition portion 28 protrudes downwards.

FIG. 3B shows a partially exploded view of the closure 50 of FIG. 3A. The closure 50 comprises a frame 54, a lid 52, a locking element 71 and the scoop holder 10. The lid 52 is formed as a die-cut plate of card with the same general shape as the scoop holder 10, also being bowed upwards in a central region 51.

FIG. 3C shows a cross-sectional view through the closure 50 of FIG. 3A on the sagittal plane X-Z. The plate 12 and the lid 52 are coextensive and adhesively attached to one another by their surfaces, this way offering a double-layer closure with a durable and solid construction. The lid 52 is connected to the frame 54 by a folded seam, which forms an upwardly extending lid rim 55 at the top of the lid 52 and a cavity C with a height h2 corresponding to a height of the frame 54. The frame 54 extends downwards to a closure skirt 53 having a slightly larger cross-section than the lid rim 55. The peripheral section 17 of the plate rim 13 is floating with respect to the edge of the lid 52. This configuration allows the peripheral section 17 to flex when pressure is applied on the upper surface of the plate 12.

Between the lid rim 55 and the cavity C, a locking element, in this case a latch 71, is pivotally mounted through the lid 52 and plate 12. An upper part 73 of the latch 71 extends upwardly from the lid 52, while the lower part 74 has a slit 75 and extends downwards under the plate 12. A cover 76 is adhesively connected to the upper part 73 to retain it to the lid 52. In the view of FIG. 3C, it can be seen that the aperture 18 is offset below from the underside of the lid 52, providing together with the cavity C means for a scoop to be stored and held underneath the closure 50.

FIG. 4A shows a perspective view of a card-based package 100 for an infant formula according to an embodiment of the present invention. The package 100 comprises a container 60 and the closure 50 as described above, the container 60 also consists essentially of card-based material.

FIG. 4B shows a partially exploded view of the package of FIG. 4A, showing a scoop 80 between the closure 50 and the container 60. The container 60 comprises a collar 62 which has at the top an upper peripheral closure rim 64 defining an access opening Op to an interior space, for receiving the infant formula. Thus, in this embodiment, the closure 50 is arranged for selectively closing the access opening Op.

FIG. 4C shows a cross-sectional view through the package of FIG. 4A on the sagittal plane X-Z. The container 60 is made from a card blank, joined to itself in a longitudinal seam (not shown) to form a sidewall 63 in the form of a tube with constant or near constant, outer cross-section. At its bottom, base 61 and sidewall 63 of the container 60 are joined together by a folded seam which closes the lowest part of the container 60. The material of the base 61 may also meet the same requirements as the sidewall 63 and may differ e.g. only by the absence of markings or branding. A seal 68 is attached onto the upper peripheral edge of the container 60, which ensures appropriate hermetic sealing prior to use. The collar 62 is connected to the container 60 by a snap-fit joint formed between a flange 66 and a circumferentially extending groove 67. Additionally, the collar 62 may be glued to the upper peripheral edge of container 60 to ensure proper permanent sealing.

In this embodiment the container 60 comprises an insert 69 formed by a die-cut plate of card material, with an aperture corresponding to the package access opening Op and comprising scoop leveller 65 and detent 72. The insert 69 is folded over to form scoop leveller 65 and, on a lateral region, folded upwards out of the plane into a triangular or prismatic shape to form detent 72.

The insert 69 is connected to the collar 62 in a folded seam to form the upper peripheral closure rim 64 that has a slightly smaller outer cross-section that the rest of the collar 62, as shown in FIG. 4D. In the closed position of the closure 50, the closure skirt 53 covers the outer circumferential surface of the upper peripheral closure rim 64, forming a joint between the lid 52 and the collar 62. The folded seams of the closure skirt 53 and the upper peripheral closure rim 64 of the container 60 ensure that these elements are relatively rigid and can form a tight interference fit. Importantly, high manufacturing tolerances can be achieved ensuring that any gaps are smaller than 70 microns, ensuring adequate insect-tightness. In this embodiment, the peripheral section 17 acts as a gasket, flexing into engagement with the upper peripheral closure rim 64. The peripheral section 17 also extends to meet the closure skirt 53, providing additional support for the lid 52 and further enhancing the gasket function.

In the enlarged view of FIG. 4D, the lid 52 of the closure 50 can be seen locked to the collar 62. The detent 72 resides in the slit 75 of the latch 71, effectively retaining the lid 52. To unlock the lid 52, the upper part 73 of the latch 71 is pushed radially outwards, acting as a lever arm such that the slit 75 releases the detent 72. A pulling movement upwards on the lid 52 allows a user to open the package 100.

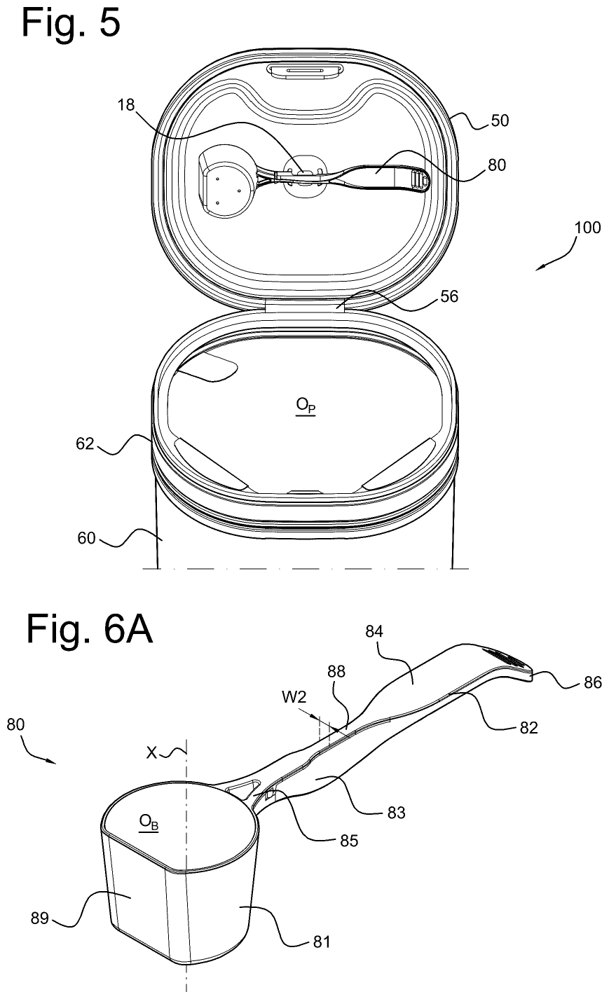

FIG. 5 shows a front view of the package 100 of FIG. 4A with the closure open. The package 100 comprises a living hinge 56 formed of card-based material, pivotally connecting the closure 50 to the collar 62. The hinge 56 is aligned with the aperture 18 so that the scoop 80 may be retained in a position aligned with the hinge 56.

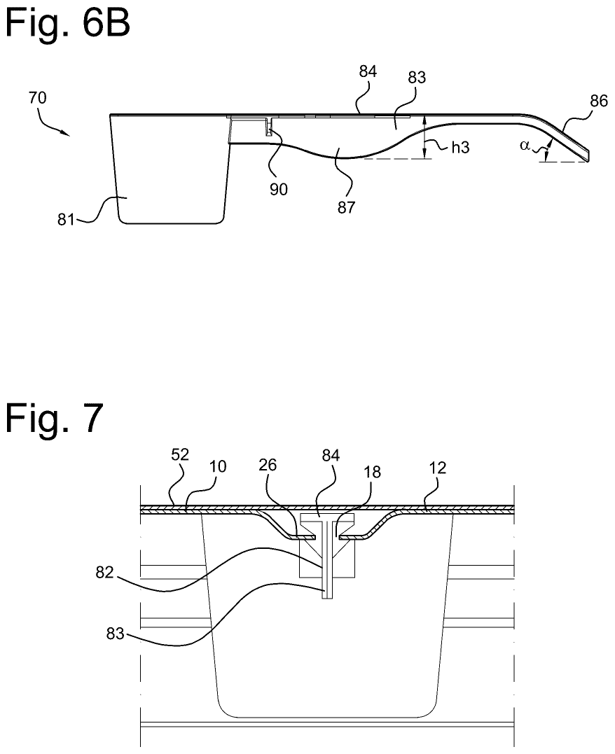

FIG. 6A shows a perspective view of a scoop according to an embodiment of the present invention. The scoop 80 is made of a bioplastic, meaning that it is biodegradable as it does not use petroleum as a raw material. The scoop 80 comprises a handle 82, having a T-shaped cross-sectional profile and a bowl 81 with a top open to receive the infant formula. The bowl 81 has a cylindrical shape with a flattened front side 89 and a longitudinal axis X-X extending from the top to the bottom of the cylinder, its opening O_{B} is substantially circular to easily dispense the powdered infant formula into a baby bottle, or other container with a narrow opening, without spillage. A front 89 of the bowl 81 has a planar surface extending perpendicular to the opening O_{B}, which provides the spoon 80 a shovel function to scrape the last bit of infant formula from the container 60.

The handle 82 has a first end 85 connected to a rear of the bowl 81, a free second end 86 and a middle section 88. The handle 82 comprises a planar top portion 84 (the top of the T) extending from an upper edge of the bowl 81 and at the same level of its opening O_{B}, which provides the scoop 80 with a flat top surface that easily slides underneath the plate 12 of the scoop holder 10. The top portion 84 is reduced in width in the middle section 88, having a width W2 that is slightly less than the width W1 of the aperture 18 of the scoop holder 10.

The handle 82 comprises a web 83 (forming the stem of the T) extending perpendicularly downwards from the top portion 84. The web 83 has a middle section 87 with a height h3 than facilitates gripping of the handle 82 by the user, as shown in FIG. 6B. At the first end 85, a stop 90 is formed between the top portion 84 and the web 83. The second end 86 of the handle 82 is inclined downwards at an angle similar to the transition angle α. This shape guides the user with respect to the correct position of the scoop 80 relative to the plate 12 and secures the scoop 80 laterally while it is being held by the scoop holder 10. The scoop 80 may be of any appropriate size for dosing of infant formula, in particular it may have a bowl 81 with a volume of between 2 ml and 20 ml, preferably between 6 ml and 20 ml and in particular between 8 ml and 14 ml. A typical mass for a scoop formed of bioplastic would lie in the range of from 1.9 g to 2.4 g depending on its volume.

FIG. 7 shows a cross-section through a central region of the closure 50 with the scoop holder 10 holding the scoop 80. Connection of the scoop 80 with the scoop holder 10 takes place by inserting the middle section 88 through the stem 22 of the aperture 18. The user can grip the middle section 87 of the web 83 during this motion. The scoop 80 is then slid sidewise within the aperture 18 until the stop 90 abuts against the ends of the flaps 26. This prevents further motion of the scoop 80 and assures that the wider first end 85 of the top portion 84 is retained within the aperture. In FIG. 7, The top portion 84 of the handle 82 of the scoop 80 is located within the aperture 18 of the plate 12 with the cross of the T located in the crosses 20 of the I and the web 83 extending downwards through the stem of the I. The scoop 80 is kept in a stable position by the flaps 26 supporting the narrow middle section 88 of the handle 82 and abutted against the stop 90.

Thus, the invention has been described by reference to certain embodiments discussed above. It will be recognized that these embodiments are susceptible to various modifications and alternative forms well known to those of skill in the art. Many modifications in addition to those described above may be made to the structures and techniques described herein without departing from the scope of the invention. Accordingly, although specific embodiments have been described, these are examples only and are not limiting upon the scope of the invention.

1-27. (canceled)

28. A closure for an infant formula package, the package comprising a container having an access opening to an interior space for receiving the infant formula, whereby the closure is arranged for selectively closing the access opening, the closure comprising a lid with a scoop holder located at an underside of the lid to retain a scoop, wherein the scoop holder comprises an apertured plate having an apertured portion with an aperture therethrough to receive at least part of the scoop, and wherein both the lid and the scoop holder are formed of card-based material.

29. The closure according to claim 28, wherein the apertured plate comprises an attachment portion attached to the lid and surrounding the apertured portion.

30. The closure according to claim 28, wherein the scoop holder is substantially co-extensive with the lid.

31. The closure according to claim 28, wherein the aperture is shaped to match at least part of an outline of the scoop, to prevent motion of the scoop within a plane parallel to the apertured plate.

32. The closure according to claim 28, wherein the apertured portion comprises a strip, crossing the aperture and connected to opposite sides of an edge of the aperture to form a loop extending downwards from the apertured plate, allowing a handle of the scoop to slide through and underneath of the apertured plate.

33. The closure according to claim 32, wherein the loop is shaped to enclose a segment of the handle of the scoop.

34. The closure according to claim 29, wherein the apertured portion protrudes downwards, out of a plane of the attachment portion whereby the aperture is spaced from the underside of the lid.

35. The closure according to claim 34, wherein the scoop holder comprises a transition portion between the attachment portion and the apertured portion and the aperture extends at least partially into the transition portion.

36. The closure according to claim 35, wherein the aperture is I shaped and the crosses of the I are located in the transition portion.

37. The closure according to claim 36, wherein edges of the aperture in the apertured portion form flaps that can engage the handle of a scoop inserted along an axis of the I.

38. The closure according to claim 28, wherein a peripheral edge of the apertured plate is arranged to engage with the container.

39. The closure according to claim 38, wherein the peripheral edge of the apertured plate extends downwardly to a position below a level of the apertured portion.

40. The closure according to claim 28, further comprising a hinge, pivotally connecting the lid to the container and formed of card-based material.

41. The closure according to claim 28, wherein the card-based material consists of at least 85 wt % paper.

42. A package for infant formula comprising:
a container having an access opening to an interior space for receiving the powdered infant nutrition,
a closure arranged for selectively closing the access opening, the closure comprising a lid with a scoop holder located at an underside of the lid to retain a scoop and a hinge pivotally connecting the lid to the container, wherein the scoop holder comprises an apertured plate having an apertured portion with an aperture therethrough to receive at least part of the scoop, and
a scoop; wherein at least the container and the closure are formed of card-based material.

43. The package according to claim 42, wherein the scoop is also formed of card-based material.

44. A method of manufacturing a scoop holder, the method comprising:
providing a plate shaped portion of card-based material,
cutting an aperture into the plate to form an apertured plate, and
attaching the apertured plate at least by its rim at an underside of a lid.

45. The method of claim 44, wherein the aperture is cut to match at least part of an outline of a scoop.

46. The method of claim 44, further comprising connecting a strip across the aperture, and attaching the strip to opposite sides of an edge of the aperture thereby forming a loop extending downwards from the apertured plate.

47. The method of claim 44, further comprising deforming the plate into a dish shape with a rim and with the aperture at a bottom of the dish.
